(19) United States
(12) Patent Application Publication
(10) Pub. No.: US 2025/0250497 A1
(43) Pub. Date: Aug. 7, 2025

(54) APPLICATION OF LOW-GRADE WASTE HEAT TO BIOMASS

(71) Applicant: MOTE, INC., Los Angeles, CA (US)

(72) Inventor: Joshuah STOLAROFF, Los Angeles, CA (US)

(73) Assignee: MOTE, INC., Los Angeles, CA (US)

(21) Appl. No.: 18/856,988

(22) PCT Filed: Apr. 18, 2023
(86) PCT No.: PCT/US2023/018965

§ 371 Date: Oct. 15, 2024

Related U.S. Application Data
(60) Provisional application No. 63/332,559, filed on Apr. 19, 2022.

(51) Int. Cl. C10J 3/48

(52) U.S. Cl. CPC C10J 3/48; C10J 2300/0916; C10J 2300/1284

(57) ABSTRACT

A system and method for the generation of syngas from the gasification of biomass is disclosed herein. The system makes use of heat generated during gas compression, and recycles this heat to other process streams within the system, such as biomass drying.

### CROSS REFERENCE TO RELATED APPLICATIONS

This application claims the benefit of priority to U.S. Provisional Patent Application Ser. No. 63/332,559, filed Apr. 19, 2022, which is incorporated by reference herein in its entirety.

### BACKGROUND AND FIELD

### I. Field

This disclosure and the associated invention(s) relate at least to the field of renewable fuels production, and in particular, systems and methods for carrying out biomass gasification.

### II. Background

Due to fast climate change and foreseen damage through global warming, access to clean and green energy has become essential for the sustainable development of a global society. Biomass is one of the important renewable energy resources, as it is rich in energy and oftentimes considered an unwanted waste product.

Biomass, is a renewable organic resource, and includes but is not limited to agriculture crop residues, forest residues, special crops grown specifically for energy use (such as switchgrass or willow trees), organic municipal solid waste, and animal wastes. This renewable resource can be used to produce syngas, along with other byproducts, by gasification. The syngas consists primarily of hydrogen, carbon monoxide, and carbon dioxide.

Biomass gasification is a pathway that uses a partial oxidation process involving heat, steam, and oxygen to convert biomass to hydrogen and other products. Biomass growth removes carbon dioxide from the atmosphere, and net carbon emissions are typically low. Carbon from the process may be captured and stored for use.

Among the various routes available for biomass-based energy generation, biomass gasification is one of the most important routes that is being studied extensively. Due to the increasing interest in biomass gasification, several energy producers have developed and attempted to optimize biomass gasification systems. One of the major problems associated with biomass gasification is efficiency. Although large quantities of energy are generated during biomass gasification, each process unit within a biomass gasification plant represents a potential point of heat loss. The present invention(s) seeks to overcome these issues and others as will be explained in detail below.

### SUMMARY

This present inventions provide methods of increasing the efficiency of a biomass gasification system by recycling heat generated within the system. By recycling heat that would otherwise be lost to the atmosphere, the inventors have developed a method to increase the overall efficiency of biomass gasification systems. For a gasification plant capacity of 350 short tons of biomass per day on an as-fed basis, approximately 12 GJ/h of heat can be utilized. This degree of heat utilization represents a major contributor to plant efficiency.

In some aspects, a method and/or system for recycling low grade waste heat from a biomass gasification process is disclosed. In some aspects, a method and/or system for recycling low grade waste heat from a CO₂ capture and storage process is disclosed. In some aspects, a method and/or system for recycling low grade waste heat from H₂ liquefaction is disclosed. In some aspects, a method and/or system for recycling low grade waste heat from tail gas compression is disclosed. In some aspects, a method and/or system for recycling low grade waste heat from syngas compression is disclosed.

Synthesis gas, or syngas, is the term for raw gas produced from gasification of a biomass feedstock. Syngas consists of hydrogen (H₂) and carbon monoxide (CO) as primary components, and carbon dioxide (CO₂) and methane (CH₄) as secondary components.

In some embodiments, disclosed herein are methods of recycling low grade waste heat, comprising compressing a gas stream at a compressor to form a compressed gas stream and waste heat, cooling the compressed gas stream by thermally contacting the compressed gas stream with a heat exchanger having a cool air stream therein to heat the cool air stream to produce a warm air stream, and drying a biomass by thermally contacting the biomass with the warm air stream to reduce moisture in the biomass. In some embodiments, a gas stream is carbon dioxide, dihydrogen, syngas, and/or tail gas. In some embodiments, a heat exchanger is recuperative (e.g., indirect, direct, and/or special) and/or regenerative (e.g., static and/or dynamic). In some embodiments, a heat exchanger comprises a radiator. In some embodiments, a compressed gas stream cooling air stream and the outflowing warm air stream are moved by the same mechanical unit (e.g., by a dual-function blower).

In some embodiments, a biomass for drying is a wetter biomass and/or a dryer biomass. In some embodiments, a biomass is comprised in a biomass feed drying unit, and the biomass is dried therein. In some embodiments, a biomass feed drying unit comprises a rotary dryer, and/or a direct-heated air dryer. In some embodiments, a biomass in a biomass feed drying unit is dried for about 30 minutes to about four hours. In some embodiments, a biomass comprises agriculture crop residues, forest residues, special crops grown specifically for energy use, algae, seaweed, organic municipal solid waste, and/or animal wastes. In some embodiments, a biomass moisture content is reduced by about 2.5% to 98%, including the range endpoints relative to the biomass prior to drying. In some embodiments, a biomass moisture content is reduced by exactly, at least, or about 2.5%, 5%, 10%, 15%, 20%, 25%, 30%, 35%, 40%, 45%, 50%, 55%, 60%, 65%, 70%, 75%, 80%, 85%, 90%, 95%, or 98% relative to the biomass prior to drying. In some embodiments, moisture content of a biomass is normalized to a consistent level. In some embodiments, normalization of a biomass moisture levels improves process efficiency. In some embodiments, drying of a biomass decreases the volume and/or mass of the biomass, and/or increases the energy basis throughput of the biomass relative to an undried biomass.

In some embodiments, a recycled low grade waste heat is used to produce a warm air stream. In some embodiments, the warm air stream is exactly, at least, or about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85° C., or any range derivable therein. In some embodiments, a warm air stream is between about 20-80° C. In some embodiments, a warm air stream is between about 50-80° C. In some embodiments, a warm air stream is between about 60-70° C. In some embodiments, a warm air stream is coupled with high grade heat energy produced through traditional means, or high grade heat energy recycled from another source of waste heat.

In some embodiments, methods and/or systems described herein result in one or more of improved thermal efficiency, higher production rate per unit of a gas stream feed substrate, reduced electrical demand, and/or capital savings for a facility comprising a gas stream compressor.

In some embodiments, disclosed herein is a system for recycling low grade waste heat, comprising a biomass, a biomass drying unit, a gasification unit, a compressor, waste heat, a heat exchanger, and a heat transfer unit. In some embodiments, a heat transfer unit moves waste heat collected by a heat exchanger from a gas compressor to a biomass and/or biomass drying unit.

In some embodiments, disclosed herein is a system for recycling low grade waste heat comprising a biomass, a biomass drying unit, a gasification unit, a syngas compression unit, a plurality of water gas shift units, a plurality of contaminant removal units, a CO₂ removal unit, a CO₂ compressor, a tail gas compressor, and/or H₂ liquefaction unit, waste heat, a heat exchanger, and a heat transfer unit. In some embodiments, a heat transfer unit moves waste heat collected by a heat exchanger from the syngas compression unit, CO₂ compressor, tail gas compressor, and/or H₂ liquefaction unit to a biomass and/or biomass drying unit. Throughout this application, the term “about” is used to indicate that a value includes the inherent variation of error for the measurement or quantitation method.

As used herein, various terminology is used for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed configuration, the term “substantially” may be substituted with “within [a percentage] of” what is specified, where the percentage includes 0.1, 1, 5, and 10 percent.

Throughout this application, the term “about” is used to indicate that a value includes the inherent variation of error for the measurement or quantitation method. In various embodiments, as used herein, the term “about” refers to include the usual error range for the respective value readily known. Reference to “about” a value or parameter herein includes (and describes) embodiments that are directed to that value or parameter per se. For example, description referring to “about X” includes description of “X”. In some embodiments, “about” may refer to ±15%, ±10%, ±5%, or ±1% as understood by a person of skill in the art.

The use of the word “a” or “an” when used in conjunction with the term “comprising” may mean “one,” but it is also consistent with the meaning of “one or more,” “at least one,” and “one or more than one.”

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or. Similarly, the phrase “A, B, C, or a combination thereof” or “A, B, C, or any combination thereof” includes: A alone, B alone, C alone, a combination of A and B, a combination of A and C, a combination of B and C, or a combination of A, B, and C.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The compositions and methods for their use can “comprise,” “consist essentially of,” or “consist of” any of the ingredients or steps disclosed throughout the specification. Compositions and methods “consisting essentially of” any of the ingredients or steps disclosed limits the scope of the claim to the specified materials or steps which do not materially affect the basic and novel characteristic of the claimed invention(s). Any implementation of any of the systems, methods, apparatus, and article of manufacture can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Apparatus, systems, and methods “consisting essentially of” any of the components, apparatus, or steps disclosed limits the scope of the claim to the specified materials or steps which do not materially affect the basic and novel characteristic of the claimed implementation. Additionally, the term “wherein” may be used interchangeably with “where”.

It is contemplated that any embodiment discussed in this specification can be implemented with respect to any method or composition of the invention, and vice versa. Furthermore, compositions of the invention can be used to achieve methods of the invention.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention(s). Invention(s) may be better understood by reference to one or more of these drawings in combination with the detailed description of specific embodiments presented herein.

FIG. 1 is a schematic representation of a syngas generation process and H₂ production plant 111 in accordance with various aspects of the present disclosure. Shown are four options for capturing waste heat using any one or more of heat exchangers 75A, 75B, 75C, and 75D to capture the waste heat as any one or more of heated streams (76), (77), (78) and (79), wherein heated stream (76) is formed with recycled waste heat generated during CO₂ compression, wherein heated stream (77) is formed with recycled waste heat generated during hydrogen liquefaction, wherein heated stream (78) is formed with recycled waste heat generated during tail gas compression, and wherein heated stream (79) is formed with recycled waste heat from syngas compression. These options can be used alone, or in any combination. As shown in FIG. 1, 102 comprises biomass, 104 comprises a biomass feed preparation system, 103 comprises a biomass feeding system, 106 comprises a gasification system, 108 comprises a post gasification system, 110 comprises spent fines and spent bed material, 112 comprises a syngas compression system, 114 comprises a water gas shift system, 116 comprises an H₂S removal system, 118 comprises a CO₂ compression system, 120 comprises a CO₂ removal system, 122 comprises an H₂ separation system, 124 comprises a power generation system, 126 comprises flue gas, 128 comprises a hydrogen liquefaction system, 130 comprises CO₂ for sequestration, and 132 comprises a tail gas compression system.

FIG. 2 is a schematic representation of a syngas generation process in accordance with various aspects of the present disclosure.

FIG. 3 is a schematic representation of an integrated simulation of an H₂—BiCRS process generated using Aspen Plus software. The CO₂ separation subsystem of the facility is shown. Of note, Cooler 2 is an example of a potential source for low-grade heat and blower air. Biomass/syngas/H₂ are represented in lines 23, 25, 26, 27, 29, 30, 31, 34, 35, 37, and 38; Water/Condensate are represented in lines 24, 28, 32, 33, 36, and 39; and CO₂ is represented in line 40. TEG stands for Thermoelectric Generator.

FIG. 4 is a schematic representation of a syngas cooling unit, in accordance with various aspects of the present disclosure. As shown in FIG. 4, 302 comprises a thermoelectric generator, 304 comprises a heat exchanger system, 306 comprises a cooler system, 308 comprises a flash system, 310 comprises an absorber system, 312 comprises a cooler system, 314 comprises a recycle compressor, 316 comprises a flash system, 318 comprises a flash system, 320 comprises a flash system, 322 comprises a compressor system, and 324 comprises a circulation pump system.

### DETAILED DESCRIPTION

One of the general challenges with biomass gasification systems is the moisture content of biomass feed. The moisture content of raw biomass is naturally high, (e.g., in some embodiments, 50% water by mass) and higher proportions of water reduce the thermal efficiency of the system and reduce the heating value of syngas produced by the gasifier. In addition, the feed rate of a gasifier is typically limited by the mass and/or volume of the feed. A drier feed allows a higher throughput of feed on an energy basis, and thus allows a higher production rate of, e.g., product hydrogen for the same size of gasification equipment. A related challenge is that moisture content of biomass is variable by source, climate, and season, whereas consistent moisture content is desirable for reliable operation of the gasifier and downstream equipment. These challenges and others are described in further detail in “Getting to Neutral-Options for Negative Carbon Emissions in California” by Sarah E. Baker et al., 2020, which is incorporated by reference herein for the purposes described herein.

One common solution to these challenges is to actively pre-dry the biomass feed using high-grade heat, e.g., from natural gas or from processes elsewhere in the facility. However, using high-grade heat in this way is costly, either in fuel or in foregoing other uses of the process heat, which leads to diminishing returns for pre-drying biomass. When producing renewable hydrogen, using natural gas is additionally harmful to the product's environmental profile and may be categorically disallowed.

Low grade waste heat (e.g., T<70° C.) is common in industrial processes, but especially so in proposed designs for Dihydrogen (H₂) Biomass Carbon Removal and Storage (BiCRS) (H₂—BiCRS). Each of CO₂ compression for geologic storage, syngas compression prior to water gas shift, and H₂ compression and/or liquefaction require intercooling between compression stages, commonly at 40-50° C. Each of these compression stages constitute a major fraction of energy loss in an overall system. Current systems for H₂ liquefaction are overall thermally inefficient and comprise the majority of electrical demand in proposed H₂—BiCRS designs.

Disclosed herein are methods and systems for addressing the aforementioned challenges. In some embodiments, disclosed are methods and systems that recycle and/or capture low-grade waste heat from compressor intercooling and other sources. In some embodiments, captured low-grade waste heat is used in biomass pre-drying. In some embodiments, captured low-grade waste heat is used instead of or in addition to traditional biomass drying methodologies (e.g., drying with high grade heat).

In some embodiments, disclosed are methods and/or systems that comprise, consist of, or consist essentially of three aspects: 1) active air cooling of compressed gas streams to produce warm air (e.g., 20-70° C. depending on ambient and/or operating conditions), via an assembly including radiators and/or heat exchangers; 2) conveyance of the warm air from the compressors (e.g., comprising compression trains) to a biomass pre-treatment area via low-pressure-drop ducting; and 3) drying of a biomass feed via direct contact with warm air as generated and conveyed in steps 1 and 2.

In some embodiments, methods disclosed herein can improve thermal efficiency of a plant, generate higher production rate of product (e.g., better capital utilization of the gasifier), and/or capital savings by dual-function use of blowers (e.g., blowers that force air across cooling surfaces also move air through biomass drying equipment).

Biomass drying by recovered low grade heat has been studied and piloted (for example, Dahau et al., 2020; which is incorporated herein by reference for the purposes described herein), however the process described therein is focused on heat recovery from power cycles. In some embodiments, methods and systems described herein do not comprise heat recovery from power cycles. In some embodiments, a key innovation described herein is the integration of compressor intercooling with biomass drying. In some embodiments, this is especially advantageous in the context of H₂—BiCRS. In some embodiments, when applied to syngas and CO₂ compressors, the present disclosure applies to any BiCRS pathway, not strictly hydrogen production. In some embodiments, when applied to H₂ compressors, the present disclosure applies to any system for solid biomass conversion to hydrogen, not strictly with CO₂ capture.

In some embodiments, methods and/or systems of biomass drying disclosed herein can use a conventional configuration, for example but not limited to, a rotary dryer or other types of direct-heated air dryer. In some embodiments, biomass drying using methods and/or systems described herein differs from conventional designs, particularly in the residence time of a biomass in a biomass drying unit. For example, typical biomass residence times for conventional biomass dryers (e.g., biomass drying unit) based on high-grade heat are approximately 1 to 10 minutes. In contrast, biomass residence time in the present application is generally longer. For example, in some embodiments, biomass residence time is from 0.5 hours to 4 hours, facilitating a more effective use of lower-temperature air.

In some embodiments, biomass residence time is exactly, at least, or about 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300 minutes or any range derivable therein.

In some embodiments, a biomass has a starting moisture content from exactly, at least, or about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50% or any range derivable therein percent water by mass. In some embodiments, a biomass has a starting moisture content of about 17.2% to about 10% water by mass. In some embodiments, a biomass moisture content is reduce by exactly, at least, or about 10%, 15%, 20%, 25%, 30%, 35%, 40%, 45%, 50%, 55%, 60%, 65%, 70%, 75%, 80%, 85%, 90%, 95%, 96%, 97%, 98%, 99%, 100% or any range derivable therein. In some embodiments, a moisture content of a biomass is normalized to a consistent level. In some embodiments, a moisture content of a biomass is normalized to exactly, at least, or about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25% or any range derivable therein percent water by mass.

In some embodiments, a recycled low grade waste heat is used to produce a warm air stream. In some embodiments, in ° C., a warm air stream is exactly, at least, or about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, or any range derivable therein.

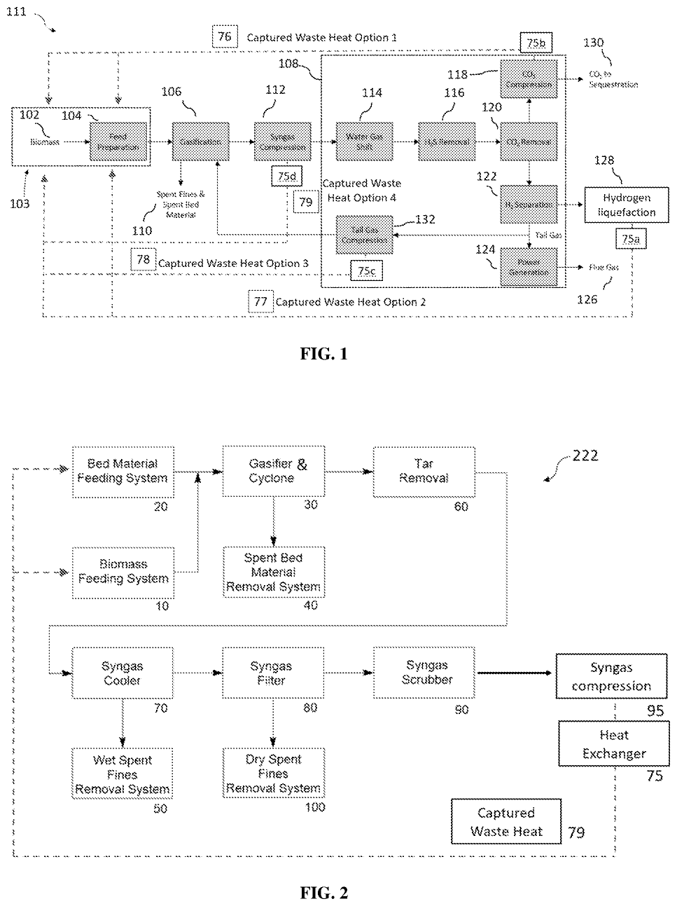

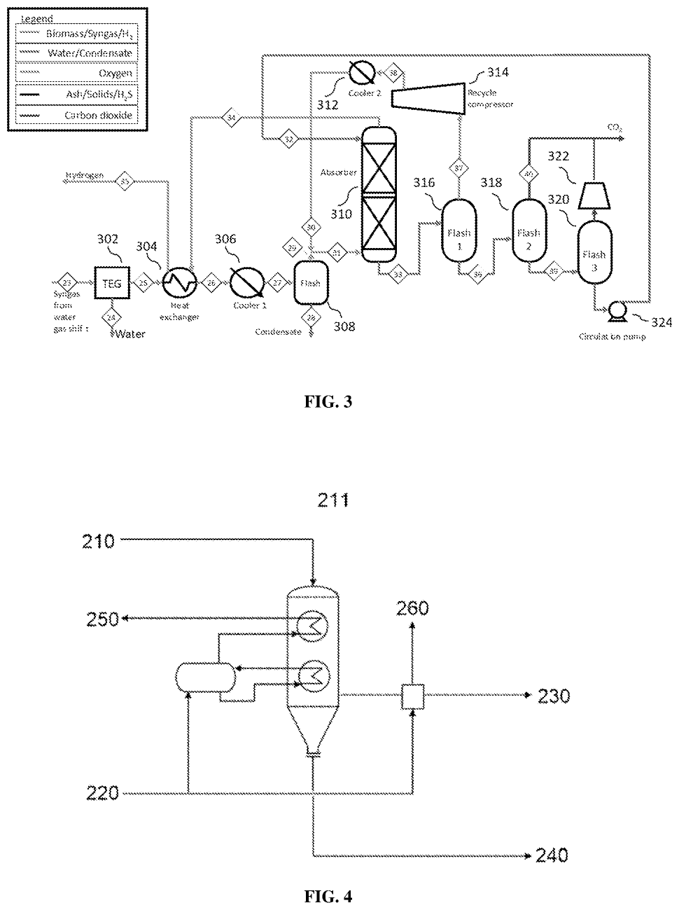

With reference to FIGS. 1 and 2, shown is a synthetic gas (syngas) generation process by a syngas generation system for gasifying biomass to ultimately produce and recover synthetic gas (syngas), and/or H₂, while capturing waste CO₂. FIG. 3 depicts a CO₂ compression system fed by biomass, syngas, and/or H₂.

The syngas generation process begins with preparation of a biomass feed to be utilized to produce syngas. The biomass may include, but is not limited to, one or more of forest biomass such as branches, brushes, etc., from forest management, sawmill residue or shrub and chaparral, agricultural residues such as but not limited to almond shells, orchard trimmings, low moisture agricultural residue, urban waste such as but not limited to dry municipal solid waste, construction wood, greenwaste, etc., or may originate from crops such as sawgrass specifically grown to be utilized as biomass.

FIG. 1 shows a schematic representation of a syngas generation process that optionally uses tail gas as fuel for removing tar, in accordance with various embodiments of the present disclosure. In addition, FIG. 1 shows a schematic representation of a number of methods for capturing low grade waste heat as described herein. Shown are four options for capturing and recycling waste heat, for example but not limited to, recycling waste heat to a feeding system 103, comprising biomass 102 and a feed preparation system 104. In certain embodiments, waste heat can be captured using any one or more of heat exchangers 75A, 75B, 75C, and/or 75D to capture the waste heat as any one or more of heated streams (76), (77), (78) and/or (79), wherein heated stream (76) is formed with recycled waste heat generated during CO₂ compression, wherein heated stream (77) is formed with recycled waste heat generated during hydrogen liquefaction, wherein heated stream (78) is formed with recycled waste heat generated during tail gas compression, and wherein heated stream (79) is formed with recycled waste heat from syngas compression.

In various embodiments, the syngas generation process 111 includes a block feeding system 103 which comprises preparation 102 of biomass feed for feeding 104 into a gasifier for gasification 106 of the biomass feed to generate syngas. The gasification process 106 also includes cyclone(s), tar removal, syngas cooling, syngas filtering, syngas scrubbing, etc., as well as the handling and removal 110 of wet spent, dry spent, spent bed material, etc. Discussions related to the preparation 102 of the biomass feed, the feeding 104 of the biomass to the gasifier, the gasification 106 of the biomass, the post-gasification processes 108 as well as the handling and removal 110 of the spent materials are provided with reference to FIG. 2, which includes more details of the noted processes. In various embodiments, the biomass feed preparation process 102 and biomass feeding 104 of FIG. 1 are performed by the biomass feeding system 10 and the bed material feeding system 20 of FIG. 2, the gasification 106 of FIG. 1 is performed by the gasifier and cyclone 30 of FIG. 2, the tar removal system 60, the syngas cooler 70, the syngas filter 80, the syngas scrubber 90 of FIG. 2, and the handling and removal processes 110 of FIG. 1 are performed by the wet spent fines removal system 50, the dry spent fines removal system 100, and the spent bed material removal system 40 of FIG. 2.

FIG. 2 shows a schematic representation of a syngas generation process in accordance with various embodiments of the present disclosure. In various embodiments, the syngas generation system 222 includes a biomass feeding system 10 that includes one or more lock-hopper-based feeding lines that feed the biomass (e.g., dried biomass 1) to the gasifier 30. Multiple feeding lines can be arranged in parallel, and one or more of them can be designed to feed biomass at even higher capacity than the intake capacity of the gasifier 30 (e.g., for a system with a capacity of about 350 sTPD, each of the one or more feeding lines can feed biomass at about 114% of the total 350 sTPD feedstock, or about 40 sTPD capacity per feed train). In some embodiments, multiple parallel, full capacity feeding lines improve the reliability of the syngas generation system 222 in the event that a feeding line is taken offline for maintenance.

In some aspects, the biomass feed is transported to the gasifier and cyclone 30 via flight chain conveyor. The biomass feeding system 10 can include a biomass distribution screw conveyor located at the top of the biomass feeding system 10 for delivering the biomass to the gasifier and cyclone 30. In some aspects, biomass is dropped from the biomass distribution screw conveyor into the biomass storage silo, which is purged with nitrogen to avoid dust explosion or self-ignition of the dried fuel. From the storage silo, the fuel is moved through the biomass storage silo discharger and biomass distribution screw into one or more (e.g., two) lock hoppers, where the biomass feedstock pressure is alternately increased from atmospheric pressure to system pressure with carbon dioxide. It is then discharged to the biomass surge hopper as described below and depressurized to begin the fill step. From the pressurized lock hoppers, the biomass is fed to biomass surge hopper with live bottom screws via lock hopper discharger. The biomass is fed from the surge hoppers through the metering screw conveyor to the biomass feeding screw conveyor that feeds the biomass into the gasifier 30.

The syngas generation process 222 also includes a bed material feeding system 20 for feeding bed material to gasifier and cyclone 30. In some aspects, the bed material comprises dolomite, kaolin, olivine, muscovite, sand, limestone, or a combination thereof. In some aspects, the bed material feeding system is a single bed material feeding lock-hopper system. In some aspects, the lock-hopper system includes a lock/surge hopper for pressurizing bed material to system pressure with nitrogen. In some aspects, the bed material feeding system comprises a diverting screw conveyor for feeding bed material to the gasifier.

In various aspects, the syngas generation system 222 includes a gasifier 30 that is designed for or configured to gasify a biomass feed received from biomass feeding system 10. In various aspects, the gasifier 30 includes a natural gas-fueled start-up heater that is used to heat the reactor of the gasifier during startup of the gasifier reactor. In some aspects, the gasifier reactor may be designed to handle biomass at a rate ranging from about 10,000 to about 15,000 kg/h biomass. In some implementations, the gasifier reactor may be designed to handle biomass at a rate of about 13,230 kg/h biomass at about 17 wt. % moisture. In some implementations, the gasifier reactor may be designed to handle biomass at a rate of about 10,000 kg/h to about 50,000 kg/h biomass, including any range derivable therein. In some implementations, the gasifier reactor may be designed to handle biomass at a rate of about 25,000 kg/h to about 40,000 kg/h biomass, including any range derivable therein. In some implementations, the gasifier reactor may be designed to handle biomass at a rate of about 39,000 to about 40,000 kg/h biomass, including any range derivable therein.

In some aspects, the gasifier reactor may be designed to handle biomass having a moisture content of from about 10% to about 25%. In some aspects, the gasifier reactor may be designed to handle biomass having a moisture content of from about 10% to about 20%. In some aspects, the gasifier reactor may be designed to handle biomass having a moisture content of from about 8% to about 12%. In specific aspects, the gasifier reactor may be designed to handle biomass having a moisture content of about 10%.

During startup, air for biomass combustion is supplied by a startup air system (e.g., outside the study battery limit) that includes an air compressor and an air receiver.

In some aspects, the biomass feed is gasified by the gasifier 30 in the presence of oxygen and superheated steam. In some aspects, the gasifier is any suitable type of gasifier, for example but not limited to a pressurized bubbling fluidized bed refractory lined pressure vessel. In some aspects, the oxygen and steam are introduced through a valve system to multiple locations in the gasifier 30. In some aspects, oxygen is preheated to a temperature of about 150° C. to about 200° C., and preferably preheated to about 175° C. in an oxygen preheater. In some embodiments, the biomass is devolatilized in the gasifier 30 while at least a portion of char is gasified and at least a portion of char is combusted to maintain the desired gasification temperature. In some aspects, the produced syngas exits the gasifier 30 at the top of the reactor. In some aspects, entrained dust is at least partially removed from the hot gas in the cyclone and returned to the reactor's fluidized bed via the cyclone return pipe (e.g., dipleg).

After syngas is generated in a gasifier and cyclone 30, the syngas is fed to tar removal system 60 for removal of tar from the syngas. The syngas may still include molten solids, remnant particulate matter, and char. In some aspects, tar removal system 60 includes a hot oxygen burner (HOB) that converts tar components and other hydrocarbon compounds into hydrogen and carbon monoxide. In the tar removal system 60, the fuel gas enters the hot oxygen burner, where the tar components and other unsaturated hydrocarbon compounds are converted into hydrogen and carbon monoxide. Reducing or eliminating heavier hydrocarbons aids with preventing their condensation in the downstream equipment. Oxidation temperature is achieved by injecting oxygen and fuel gas to the tar removal burner. In some aspects, tar removal system 60 utilizes recycled syngas that has been compressed downstream of the gasifier and cyclone 30 for fuel. In some aspects, from about 4% to about 14% of the syngas may be recycled or provided to the tar removal system 60 to serve as fuel for operating the tar removal system 60. In some embodiments, tail gas can be utilized or provided to the tar removal system to serve as fuel gas for operating the tar removal system. Both syngas and molten solids flow downward through the tar removal vessel to the syngas cooler 70.

In some aspects, the syngas generation process 222 includes a syngas cooler 70. In some aspects, syngas cooler cools syngas to a temperature ranging from about 500° C. to about 570° C., preferably to a temperature ranging from about 530° C. to about 550° C. In some aspects, syngas cooler cools syngas to a temperature of about 540° C. In some aspects, the syngas cooler includes a boiler, a superheater, and a steam drum. In some aspects, boiler feed water is sent to the steam drum of the syngas cooler 70 where it is preheated by a low pressure steam coil. In some aspects, spent fines disengage from the gas stream and drop by gravity into a water bath. In some aspects, the cooled wet spent fines are then sent to the wet spent fines removal system 50 of syngas generation system 222. In some aspects, heat recovered from the syngas cooler is used to heat boiler feed water to produce superheated steam. In some aspects, heat recovered from the syngas cooler is used to generate superheated steam. In some aspects, the superheated steam is generated at a temperature ranging from about 270° C. to about 310° C. In some aspects, the superheated steam is generated at a temperature ranging of about 288° C. In some aspects, the superheated steam is generated at a pressure ranging from about 30 barg to about 50 barg. In some aspects, the superheated steam is generated at a pressure of about 41 barg. In some aspects, the superheated steam is utilized by integrating with another process stream syngas generation process 111. In some aspects, syngas leaving syngas cooler 70 is further cooled by boiler feed water (BFW) spray to approximately 300° C. before it is sent to syngas filter 80.

In some aspects, heat is recovered from syngas exiting the syngas cooler by a heat exchanger 260 (FIG. 4). In some aspects, heat recovered by the heat recovery unit is used to produce a secondary steam stream 270 (FIG. 4). In some aspects, heat recovered by heat exchanger 260 is utilized by integrating with another process stream syngas generation process 222. In some aspects, heat recovery using heat exchanger 260 is performed as an alternative to cooling by BFW spray. In some aspects, heat recovered from the syngas cooler is used to generate superheated steam.

In some aspects, syngas cooled by the syngas cooler is then sent to syngas filter 80. In some aspects, syngas leaving the syngas cooler is at a temperature ranging from about 250° C. to about 350° C. In some aspects, syngas leaving the syngas cooler is at a temperature of about 300° C. In some aspects, syngas cooled by the quench water stream is then sent to syngas filter 80. In some aspects, syngas cooled by the quench water stream is at a temperature ranging from about 250° C. to about 350° C. In some aspects, syngas cooled by the quench water stream is at a temperature of about 300° C.

In some aspects, the syngas filter 80 is configured to receive syngas and spent fines from the syngas cooler 70. In some aspects, the syngas filter is a candle filter unit including metal candle filter elements arranged in clusters and installed into a tube sheet. In some aspects, the filter candles are cleaned with carbon dioxide by back pulsing from the blowback tank. In some aspects, the filter unit is operated at system pressure and the pulsing gas is injected at an elevated temperature.

In some aspects, syngas generation system 222 includes a syngas scrubber 90 that is configured to receive the syngas from the syngas filter 80 and further cool the syngas to a temperature ranging from about 30° C. to about 60° C. In some aspects, syngas scrubber 90 cools the syngas to a temperature of about 45° C. In some aspects, syngas scrubber 90 removes part of the water vapor and remaining contaminants from the syngas and protects the syngas compression system and the downstream chemical processes from solids contamination in the event of hot oxygen burner or syngas filter 80 malfunction. In some aspects, syngas scrubber 90 has an inlet quench system where water is pumped by cooling pumps through nozzles into the syngas feed stream just before entry to the scrubber. In some aspects, the gas is then cooled further through a first stage bed. In some aspects, scrubber water is circulated by circulation pumps through a heat recovery heat exchanger to the top of the first stage bed. In the second stage, the gas is cooled through the second stage bed by recirculated water. In some aspects, a process condensate stream is injected at the top of the syngas scrubber 90 to allow for additional chloride removal. In some aspects, chemicals are added to the scrubber water to adjust the pH value of the water, enhance chloride removal, and/or neutralize ammonia from the syngas. In some embodiments, the syngas from the syngas scrubber is fed to a syngas compression system 95. In certain embodiments, a syngas compression system is coupled to a heat exchanger 75, and waste heat generated during syngas compression is captured and recycled 79 for use elsewhere in the system (e.g., biomass drying).

In some aspects, the syngas generation system 222 includes a solid removal system that includes spent bed material removal system 40 and dry spent fines removal system 100. In some aspects the spent bed material removal system 40 is configured to remove spend bed material from the gasifier 30. In some aspects, dry spent fines removal system 100 is configured to remove dry spent fines from syngas filter 80. In some aspects, the solid removal system is configured to store removed solids. For example, the solid removal systems 40 and 100 can include two separate solid removal systems including lock-hoppers, conveyor hoppers and storage silos designed to handle the solid material from the gasifier 30 and syngas filter 80. In some aspects, spent bed material is removed through the bottom of the gasifier 30 using a water-cooled screw to a nitrogen-pressurized lock hopper. In some aspects, spent bed material is conveyed pneumatically through a gasifier spent bed material conveyor hopper to the common gasifier spent bed material silo by using nitrogen or any other inert gas available. In some aspects, dry spent fines from the syngas filter are removed using water-cooled screws and are passed through a lock and conveyor hopper. In some aspects, a buffer hopper located after the cooling screw allows continuous operation of the screw. In some aspects, dry spent fines from the syngas filter 80 are loaded into a dry spent fines storage silo using nitrogen or any other dry inert gas available.

In various embodiments, syngas generation system 222 also includes wet spent removal system 50 that is configured to receive wet spent fines that drop in from the syngas cooler water bath. In some aspects, water from this system is recycled back to the water in the syngas cooler by a pump. In some aspects, the accumulated wet spent fines are cooled, depressurized, and removed from the wet spent removal system 50.

In various aspects, nitrogen, carbon dioxide, water, etc., that are used by the syngas generation system 222 to generate syngas can be provided by auxiliary systems that are coupled to the syngas generation system 222. For example, the auxiliary systems can include a nitrogen supply system, a carbon dioxide supply system, a water supply system, etc. The auxiliary systems can also include one or more heat exchange systems. For instance, the nitrogen supply system can supply nitrogen which can be used as an inert gas in the syngas generation system 222 and as a fuel diluent for the hot oxygen burner during start-up. In some aspects, nitrogen can supplied to the project at different pressures, for example, nitrogen can be supplied to one component of syngas generation system at a high pressure, and nitrogen can be supplied to a different component of syngas generation system at a lower pressure. In some aspects, a unique buffer drum is used at each nitrogen pressure to ensure adequate nitrogen is available for safe operation, start-up, and shutdown of the unit. In some aspects, nitrogen from the buffer drums can flow to a low-pressure and a high-pressure nitrogen header that distributes nitrogen to nitrogen consumers.

In some aspects, a carbon-dioxide supply system provides sulfur free-CO₂ to the syngas generation system 222 from an acid gas removal unit. In some aspects, this CO₂ stream is fed to unique high pressure and low pressure buffering drums in the carbon-dioxide supply system. In some aspects, CO₂ is distributed from these drums to the various components within the syngas generation system 222.

In some aspects, a water supply system includes a high-pressure cooling water system and a high-pressure sealing water system. In some aspects, the high-pressure cooling water system is used to cool the gasifier bottom spent bed material, the dry spent fines, and the biomass feeding screws. In some aspects, the cooling water system is a closed-loop system operated at high pressure. In some aspects, the loop includes circulating pumps, a storage drum, and a cooling heat exchanger. In some aspects, the high-pressure sealing water system is used to supply water to the mechanical seals of the solids removal systems and biomass feeding screw shafts. In some aspects, the loop includes circulating pumps, a storage drum, and a cooling heat exchanger.

In some aspects, the heat exchange system of the auxiliary systems is a hot process heat exchange system including a hot process cooling water system that is a closed-loop system and uses a series of pumps, storage drum, and heat exchangers to exchange heat between portions of the facility. In some aspects, the hot process water supply cools the scrubber bottoms stream and the high pressure cooling water loop water, the heated process water is then available as a heat source for biomass feed drying, as needed.

Returning to FIG. 4, in various aspects, syngas cooler 211 includes a syngas feed 210. In some aspects, the syngas feed comprises hot syngas from a tar removal unit (not depicted). The syngas from the tar removal unit may be at a temperature ranging from about 750° C. to about 950° C. Boiler feed water 220 is provided to syngas cooler 211 and to heat exchanger 260. The portion of the boiler feed water 220 that is provided to syngas cooler 211 is heated by the hot syngas within the syngas cooler and is converted to superheated steam 250. The superheated steam 250 is at a temperature ranging from about 270° C. to about 310° C., and a pressure ranging from about 30 barg to about 50 barg. After passing through syngas cooler 211, the syngas temperature has been reduced to a temperature ranging from about 500° C. to about 570° C. The cooled syngas then passes to secondary heat exchanger 260 where heat is absorbed from the syngas, and the syngas is further cooled to provide cooled syngas 230 at a temperature ranging from about 250° C. to about 350° C. Spent fines 240 from the syngas are collected as a stream exiting a bottom portion of syngas cooer 211. Heat exchanger 260 can be used to transfer heat to boiler feed water 220 to produce a secondary steam stream 270. Heat from secondary steam stream 270 can be utilized by integrating with another process stream within syngas generation process 222 (FIG. 2).

Returning to FIG. 1, in various embodiments, the tar removal system 60 can optionally use the tail gas that is generated as a by-product of the post-gasification process 108 as fuel for the removal of tar from the syngas. For example, as shown in FIG. 1, the syngas that results from the gasification 106 may be compressed and undergo a water shift process (e.g., multi-stage water shift process). The syngas is further processed to remove H₂S, CO₂, and H₂ (e.g., via pressure swing adsorption), which results in a tail gas by-product. In various embodiments, these tail gas by-product can be recycled or provided to the tar removal system for use as fuel in the tar removal process in gasification 106. In some instances, the tail gas may be compressed before being routed to the tar removal system. That is, in addition to or instead of using the tail gas for power generation and fueling the boiler, the tail gas may be provided to the tar removal system 60 (FIG. 2) so that the tar removal system 60 can operate using the tail gas by-product as fuel to remove or reduce the tar in the synthetic gas generated by the syngas generation system 222. In some instances, recycled syngas may also be used as fuel to power the tar removal system 60. In some instances, no recycled syngas may be used as fuel but instead the recycled tail gas may be used as fuel for the tar removal system 60 to remove tar from syngas. In certain embodiments, a tail gas compression system is coupled to a heat exchanger 75, and waste heat generated during tail gas compression is captured and recycled 77 for use elsewhere in the system (e.g., biomass drying).

In some embodiments, methods and systems described herein can be utilized to improve capital efficiency and/or product yield. Information regarding capital efficiency and/or product yield and methods to determine the same can be found in “Getting to Neutral-Options for Negative Carbon Emissions in California” by Sarah E. Baker et al., 2020, which is incorporated herein by reference for the purposes described herein.

### ASPECTS

The following aspects describe certain inventions disclosed herein.
Aspect 1) A method of recycling low grade waste heat, comprising: compressing a gas stream at a compressor to form a compressed gas stream and waste heat, cooling the compressed gas stream by thermally contacting the compressed gas stream with a heat exchanger having a cool air stream therein to heat the cool air stream to produce a warm air stream, and drying a biomass by thermally contacting the biomass with the warm air stream to reduce moisture in the biomass.
Aspect 2) The method of aspect 1, wherein the gas stream is carbon dioxide.
Aspect 3) The method of aspect 1, wherein the gas stream is dihydrogen.
Aspect 4) The method of aspect 1, wherein the gas stream is syngas.
Aspect 5) The method of aspect 1, wherein the gas stream is tail gas.
Aspect 6) The method of any one of aspects 1-5, wherein the heat exchanger comprises a radiator.
Aspect 7) The method of any one of aspects 1-6, wherein the compressed gas stream cooling and the transfer of the warm air stream are performed by a dual-function blower.
Aspect 8) The method of any one of aspects 1-7, wherein the biomass comprises a wetter biomass and/or a dryer biomass.
Aspect 9) The method of any one of aspects 1-8, wherein the biomass is comprised in a biomass feed drying unit, and the biomass is dried.
Aspect 10) The method of aspect 9, wherein the biomass feed drying unit comprises a rotary dryer, and/or a direct-heated air dryer.
Aspect 11) The method of aspects 9 or 10, wherein a biomass in the biomass feed drying unit is dried for about 30 minutes to about four hours.
Aspect 12) The method of any one of aspects 1-11, wherein the biomass comprises agriculture crop residues, forest residues, special crops grown specifically for energy use, organic municipal solid waste, and/or animal wastes.
Aspect 13) The method of any one of aspects 9-12, wherein the biomass moisture content is reduced by 2.5% to 98%, including the range endpoints.
Aspect 14) The method of aspect 13, wherein the biomass moisture content is reduced by about 2.5%, 5%, 10%, 15%, 20%, 25%, 30%, 35%, 40%, 45%, 50%, 55%, 60%, 65%, 70%, 75%, 80%, 85%, 90%, 95%, or 98%.
Aspect 15) The method of aspects 13 or 14, wherein the moisture content of the biomass is normalized to a consistent level.
Aspect 16) The method of any one of aspects 9-15, wherein the drying of the biomass decreases the volume and/or mass of the biomass, and/or increases the energy basis throughput of the biomass relative to an undried biomass.
Aspect 17) The method of any one of aspects 1-16, wherein the warm air stream is between about 20-80° C.
Aspect 18) The method of any one of aspects 1-17, wherein the warm air stream is between about 50-80° C.
Aspect 19) The method of any one of aspects 1-18, wherein the warm air stream is between about 60-70° C.
Aspect 20) The method of any one of aspects 1-19, wherein the warm air stream is coupled with high grade heat energy produced through traditional means.
Aspect 21) The method of any one of aspects 1-20, wherein the method results in one or more of improved thermal efficiency, higher production rate per unit of a gas stream feed substrate, reduced electrical demand, and/or capital savings for a facility comprising a gas stream compressor.
Aspect 22) A system for recycling low grade waste heat, comprising: a biomass, a biomass drying unit, a gasification unit, a compressor, waste heat, a heat exchanger, and a heat transfer unit, wherein the heat transfer unit moves waste heat collected by the heat exchanger from the gas compressor to the biomass and/or biomass drying unit.
Aspect 23) The system of aspect 22, comprising: a biomass, a biomass drying unit, a gasification unit, a syngas compression unit, a plurality of water gas shift units, a plurality of contaminant removal units, a CO₂ removal unit, a CO₂ compressor, a tail gas compressor, and/or H₂ liquefaction unit, waste heat, a heat exchanger, and a heat transfer unit, wherein the heat transfer unit moves waste heat collected by the heat exchanger from the syngas compression unit, CO₂ compressor, and/or H₂ liquefaction unit to the biomass and/or biomass drying unit.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

To test the benefits of the cold gas recycle, the inventors performed in integrated simulation of an H₂—BiCRS process using the Aspen Plus software. The CO₂ separation subsystem of the facility is shown in FIG. 3, wherein Cooler 2 is one example of a potential source for capture and recycling of low-grade heat and blower air.

With application of the methods disclosed herein, the inventors estimated that the moisture content of incoming biomass can be substantially reduced. For example, consider a case where the as-fed moisture content is reduced from a baseline of 17.2% water to 10% water by mass. Results of the two scenarios are shown in Table 1 below. The biomass drying allows for higher productivity of the facility by about 9%, with a slight increase in cold gas efficiency (on higher heating value basis) of the gasifier.

TABLE 1
Results of H₂-BiCRS process simulation

| | | | 10 wt % |
|---|---|---|---|
| Parameter | Unit | Base case | Moisture |
| Hydrogen Produced | t/year | 6,561 | 7,122 |
| CO₂ captured | t/year | 146,239 | 158,769 |
| Cold gas efficiency (HHV) | % | 71.74 | 72.03 |

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method of recycling low grade waste heat, comprising:
compressing a gas stream at a compressor to form a compressed gas stream and waste heat,
cooling the compressed gas stream by thermally contacting the compressed gas stream with a heat exchanger having a cool air stream therein to heat the cool air stream to produce a warm air stream,
drying a biomass by thermally contacting the biomass with the warm air stream to reduce moisture in the biomass.

2. The method of claim 1, wherein the gas stream is carbon dioxide.

3. The method of claim 1, wherein the gas stream is dihydrogen.

4. The method of claim 1, wherein the gas stream is syngas.

5. The method of claim 1, wherein the gas stream is tail gas.

6. The method of claim 1, wherein the heat exchanger comprises a radiator.

7. The method of claim 1, wherein the compressed gas stream cooling and the transfer of the warm air stream are performed by a dual-function blower.

8. The method of claim 1, wherein the biomass comprises a wetter biomass and/or a dryer biomass.

9. The method of claim 1, wherein the biomass is comprised in a biomass feed drying unit, and the biomass is dried.

10. The method of claim 9, wherein the biomass feed drying unit comprises a rotary dryer, and/or a direct-heated air dryer.

11. The method of claim 9, wherein a biomass in the biomass feed drying unit is dried for about 30 minutes to about four hours.

12. The method of claim 1, wherein the biomass comprises agriculture crop residues, forest residues, algae, seaweed, special crops grown specifically for energy use, organic municipal solid waste, and/or animal wastes.

13. The method of any one of claim 1, wherein the biomass moisture content is reduced by about 2.5% to about 98%, including the range endpoints.

14. The method of claim 13, wherein the biomass moisture content is reduced by about 2.5%, 5%, 10%, 15%, 20%, 25%, 30%, 35%, 40%, 45%, 50%, 55%, 60%, 65%, 70%, 75%, 80%, 85%, 90%, 95%, or 98%.

15. The method of claim 13, wherein the moisture content of the biomass is normalized to a consistent level.

16. The method of claim 1, wherein the drying of the biomass decreases the volume and/or mass of the biomass, and/or increases the energy basis throughput of the biomass relative to an undried biomass.

17. The method of claim 1, wherein the warm air stream is between about 20-80° C.

18. The method of claim 1, wherein the warm air stream is between about 50-80° C.

19. The method of claim 1, wherein the warm air stream is between about 60-70° C.

20. The method of claim 1, wherein the warm air stream is coupled with high grade heat energy produced through traditional means.

21. The method of claim 1, wherein the method results in one or more of improved thermal efficiency, higher production rate per unit of a gas stream feed substrate, reduced electrical demand, and/or capital savings for a facility comprising a gas stream compressor.

22. A system for recycling low grade waste heat, comprising: a biomass, a biomass drying unit, a gasification unit, a compressor, waste heat, a heat exchanger, and a heat transfer unit,
wherein the heat transfer unit moves waste heat collected by the heat exchanger from the gas compressor to the biomass and/or biomass drying unit.

23. The system of claim 22, comprising: a biomass, a biomass drying unit, a gasification unit, a syngas compression unit, a plurality of water gas shift units, a plurality of contaminant removal units, a CO₂ removal unit, a CO₂ compressor, a tail gas compressor, and/or H₂ liquefaction unit, waste heat, a heat exchanger, and a heat transfer unit,
wherein the heat transfer unit moves waste heat collected by the heat exchanger from the syngas compression unit, CO₂ compressor, and/or H₂ liquefaction unit to the biomass and/or biomass drying unit.
